(19) United States
(12) Patent Application Publication
(10) Pub. No.: US 2006/0189220 A1
(43) Pub. Date: Aug. 24, 2006

(54) MSA transceiver testing device and interface for use therewith

(75) Inventors: Sylvain Duval, Vaudreuil-Dorion (CA); Harold Lebrun, Mascouche (CA); Allan Ezri, St-Laurent (CA)

Correspondence Address: BAKER & BOTTS, 30 ROCKEFELLER PLAZA, 44TH FLOOR, NEW YORK, NY, 10112, US

(73) Assignee: Daito Precision, Inc.

(21) Appl. No.: 11/061,793

(22) Filed: Feb. 18, 2005

(51) Int. Cl. H01R 4/28

(52) U.S. Cl. 439/760

(57) ABSTRACT

A system for testing transceiver modules associated to different multi-source agreement standards, comprising a transceiver testing device and an interface connection unit. The transceiver testing device comprises a processor for performing at least one testing operation on an MSA transceiver module associated to a certain multi-source agreement standard. The interface connection unit is suitable for connecting the MSA transceiver module to the transceiver testing device. The transceiver module includes a certain type of electrical connector element. The interface connection unit comprises a first connector component and a second connector component. The first connector component is adapted for being removably connecting the interface connection unit to the transceiver testing device. The first connector component is different from the certain type of connector element of the MSA transceiver module. The second connector component is suitable for connecting the interface connection unit to the certain connector element of the MSA transceiver module.

### FIELD OF THE INVENTION

The present invention relates to the field of transceiver testing, and more specifically to a testing device for performing testing operations on a plurality of transceivers belonging to different multi-source agreement (MSA) standards.

### BACKGROUND OF THE INVENTION

In the past few years, the telecommunication industry has shifted away from producing proprietary transceivers, and has moved towards developing more generic transceivers. Specifically, the manufacturers of transceivers have agreed upon common standards and formats for their products in order to reduce complexity and spur renewed profitability in the field. These common standards for optical and electrical transceivers are outlined in documents entitled multi-source agreements (MSA) that specify everything from cover package dimensions, to cage and electrical connector system specifications, to host board layouts, to electrical interfaces, to front panel bezel requirements. As such, these multi-source agreements define transceiver standards to which the majority of transceivers now apply. Some of the most popular transceiver standards include Small Form Factor (SFF), Small Form Factor Pluggable (SFP), Gigabit interface (GBIC), 300 Pin MSA, XENPAK, Xpak/X2, High Speed Form Factor Pluggable (XFP) and tunable laser standards. Transceivers that conform to one of these standards are referred to as MSA transceivers. MSA transceivers can be delivered under various physical and data link layers, either optical or electrical, as described in standards such as, but not limited to, Telcordia GR253, IEEE 802.3, IEEE 802.3ea, Fiber Channel INCITS/T11 and Project 1413-D.

Prior to putting MSA transceivers on the market, they are tested for quality control purposes. As such, manufacturers of MSA transceivers spend a considerable amount of capital on purchasing and using various test and measurement devices. A deficiency with existing test and measurement devices is that they are generally designed and built for research and development purposes, which means that they are often over-sophisticated for most testing procedures performed in a manufacturing environment. In general, the only testing procedures performed on MSA transceivers in the production lines are calibration testing, functional testing and incoming inspection testing of the “go/no go” type.

A further deficiency with existing testing and measurement devices is their complexity. This complexity contributes to the overall complexity of the manufacturing production line, which can lead to increased downtime when things malfunction.

A still further deficiency with existing test and measurement set ups is that they are generally formed of an assembly of off-the-shelf test units, such as power meters and oscilloscopes that are assembled together, and that are only able to test one aspect of the MSA transceivers at a time. As such, a considerable amount of software development must be performed in order to orchestrate all the instruments, and log their test results into a meaningful way.

In light of the above, it can be seen that there is a need in the industry for test and measurement devices that are able to simplify the testing procedures, and reduce the costs associated with testing optical and electrical MSA transceivers in manufacturing environments.

### SUMMARY OF THE INVENTION

In accordance with a first broad aspect, the present invention provides an interface connection unit suitable for connecting an MSA transceiver module to a transceiver testing device. The interface connection unit comprises a first connector component and a second connector component. The first connector component is removably connectable to the transceiver testing device and the second connector component, which is different from the first connector component, is suitable for connecting to the MSA transceiver module. The interface connection unit comprises signal pathways between the first connector component and the second connector component for enabling the transceiver testing device to perform at least one testing operation on the transceiver module when the transceiver module is connected to the transceiver testing device via the interface connection unit.

In accordance with a second broad aspect, the present invention provides an MSA transceiver testing device that comprises a connection port and a processing module. The connection port is adapted for interfacing with a first connector component of a removable interface connection unit and the processing module is adapted for causing at least one testing operation to be performed on an MSA transceiver module via testing signals transmitted through the connection port. The MSA transceiver module being tested includes a connector element for interfacing with the interface connection unit, wherein the connector element is different from the first connector component of the removable interface connection unit.

In accordance with another broad aspect, the present invention provides a system for testing transceiver modules associated to different multi-source agreement standards. The system comprises a transceiver testing device and an interface connection unit. The transceiver testing device comprises a processor for performing at least one testing operation on an MSA transceiver module associated to a certain multi-source agreement standard. The interface connection unit is suitable for connecting the MSA transceiver module to the transceiver testing device, wherein the transceiver module including a certain type of electrical connector element. The interface connection unit comprises a first connector component and a second connector component. The first connector component is adapted for being removably connecting the interface connection unit to the transceiver testing device. The first connector component is different from the certain type of connector element of the MSA transceiver module. The second connector component is suitable for connecting the interface connection unit to the certain connector element of the MSA transceiver module.

In accordance with another broad aspect, the present invention provides a method for testing transceiver modules associated to different multi-source agreement standards. The method comprises connecting a transceiver module associated to a certain multi-source agreement standard to a transceiver testing device via an intermediate interface connection unit. The transceiver module associated to the certain multi-source agreement standard includes a certain type of connector element. The intermediate interface connection unit includes a first connector component for connecting to the transceiver testing device, the first connector component being different from the certain type of connector element, and a second connector component for connecting to the certain type of connector element of the transceiver module. The method further includes performing at least one testing operation on the multi-source agreement transceiver module connected to the transceiver testing device via the intermediate interface connection unit.

In accordance with another broad aspect, the present invention provides a computer readable storage medium including a program element suitable for execution by a computing apparatus to perform a method of testing an MSA transceiver module. The method comprises exchanging at least one preliminary test signal with the MSA transceiver module for identifying to which MSA standard the MSA transceiver module belongs, and releasing a signal indicative of the MSA standard identified in the preceding step.

These and other aspects and features of the present invention will now become apparent to those of ordinary skill in the art upon review of the following description of specific embodiments of the invention and the accompanying drawings.

### BRIEF DESCRIPTION OF THE DRAWINGS

In the accompanying drawings:

FIG. 1A shows a transceiver testing system in accordance with a non-limiting example of implementation of the present invention in an assembled state;

FIG. 1B shows the transceiver testing system of FIG. 1A in an un-assembled state;

FIG. 2 shows a block diagram of the transceiver testing system of FIG. 1A;

FIG. 3 shows a transceiver testing system in accordance with a second non-limiting example of implementation of the present invention;

FIG. 4 shows a block diagram of the transceiver testing system of FIG. 3;

FIG. 5 shows a functional block diagram of a computing unit for implementing the functionality of the processing module, in accordance with a non-limiting example of implementation of the present invention;

FIG. 6 shows a flow diagram of a procedure for testing an MSA transceiver in accordance with a non-limiting example of implementation of the present invention;

FIG. 7 shows an alignment and connection device in accordance with a first non-limiting example of implementation of the present invention;

FIG. 8 shows an alignment and connection device in accordance with a second non-limiting example of implementation of the present invention.

Other aspects and features of the present invention will become apparent to those ordinarily skilled in the art upon review of the following description of specific embodiments of the invention in conjunction with the accompanying figures.

### DETAILED DESCRIPTION

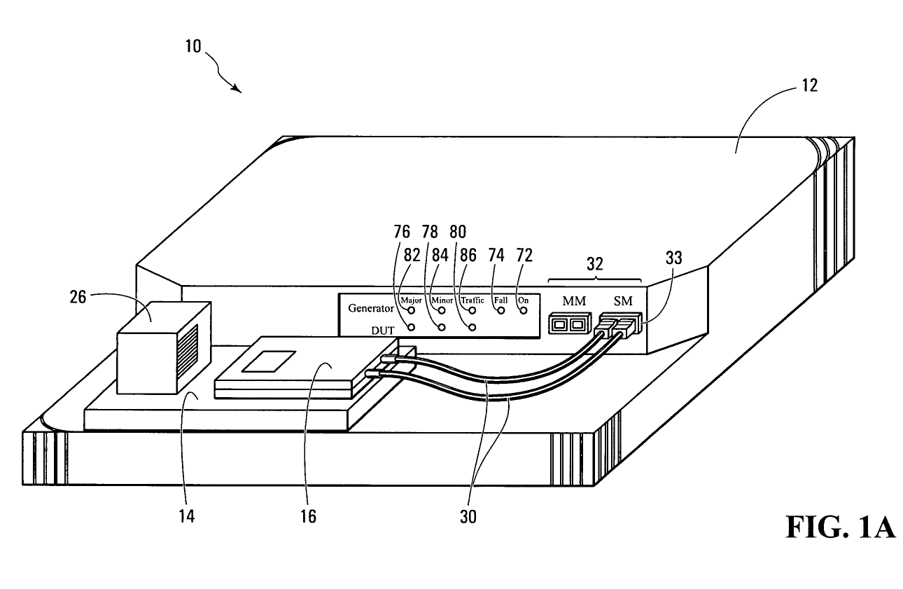

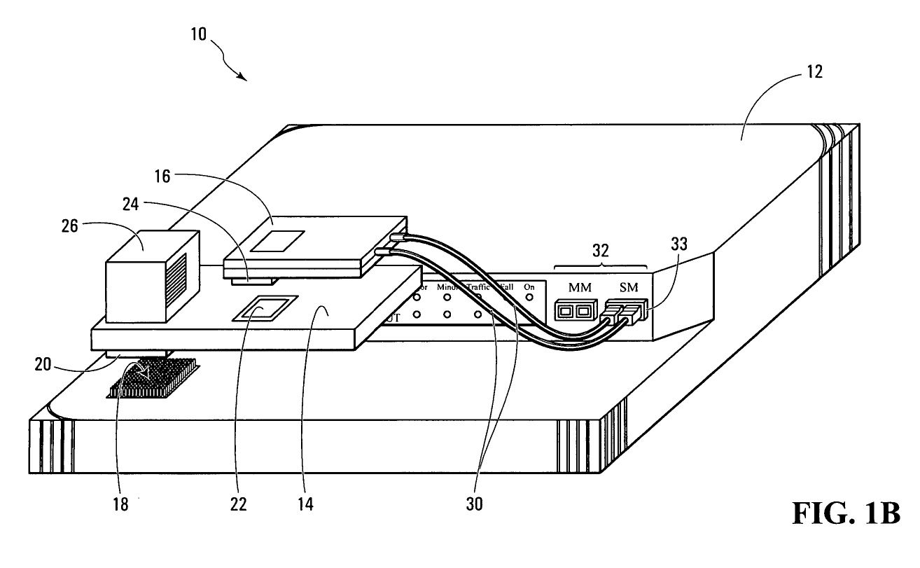

Shown in FIGS. 1A and 1B is a transceiver testing system 10 in accordance with a non-limiting example of implementation of the present invention. The transceiver testing system 10 is operative for testing transceiver modules that adhere to different multi-source agreement (MSA) standards. As shown, the transceiver testing system 10 includes a transceiver testing device 12, and at least one interface connection unit 14 for connecting an MSA transceiver module, such as MSA transceiver module 16, to the transceiver testing device 12.

In accordance with the present invention, the transceiver testing device 12 is operative for testing transceiver modules that adhere to different MSA standards. In this manner, only one transceiver testing device 12 is required for performing testing on transceiver modules belonging to different MSA standards. Some non-limiting examples of the most popular optical and electrical MSA transceiver standards include Small Form Factor (SFF), Small Form Factor Pluggable (SFP), Gigabit interface (GBIC), 300 Pin MSA, XENPAK, Xpak/X2 and High Speed Form Factor Pluggable (XFP). Furthermore, the transceiver testing device 12 can support and enable various ranges of programmable serial bandwidth: 55 Mb/s to 75 Gb/s covering emerging serial standards such as Gigabit Ethernet, 10 Gigabit Ethernet XAUI, PCI ExpressTM, SxI-5, TFI-5, Serial RapidIOTM, InfinibandTM, and Fibre Channel. The transceiver testing device's 12 electrical interfaces could support such standards such as SPI3 (POS PHY 3) SPI-4.1 (Flexbus 4), SPI4.2 (POS PHY 4), XGMII, RapidIO, PCI, PCI-X, CSIX, HyperTransportTM, XSBI, and SFI-4 using 22 single-ended and six differential electric standards including LVTTL, LVCMOS, PCI, PCI-X, HSTL, SSTL, LVDS, LVPECL and HyperTransportTM.

Optical MSA transceivers can be delivered under various wavelengths, such as 850 nm, 1310 nm and 1550 nm. They can also be delivered with CWDM or DWDM wavelength, or with a tunable laser.

Not all transceiver modules belonging to the different MSA standards have the same electrical connector 24 (shown in FIG. 1B). For example, MSA transceivers that adhere to the 300 Pin MSA standard have a 300 pin electrical connector 24, and MSA transceivers that adhere to the XENPAK, XPAK and X2 MSA standards have a 70 pin electrical connector 24. Since transceiver modules that belong to different MSA standards often have different connector types, they cannot all be connected directly to the transceiver testing device 12 via a common connection port 18 on the transceiver testing device 12.

As will be described in more detail below, it is for this reason that the transceiver testing system 10 includes at least one interface connection device 14. For each MSA standard, there is a corresponding interface connection unit 14 that includes a first connector component 20 for connecting to the connection port 18 on the transceiver testing unit 12, and a second connector component 22 for connecting to the electrical connector 24 of the transceiver modules that belong to that MSA standard. As such, each interface connection device 14 is operative for connecting transceiver modules belonging to a specific MSA standard to the transceiver testing device 12.

In the non-limiting example of implementation shown in FIGS. 1A and 1B, the transceiver testing system 10 is operative for testing optical MSA transceiver modules. However, as will be described further on in the specification, transceiver testing systems 10 that are operative for testing electrical MSA transceiver modules, or both optical and electrical MSA transceiver modules, are also included within the scope of the present invention.

The interface connection units 14 and the transceiver testing device 12 will now be described in more detail below with respect to FIGS. 1A and 1B.

Interface Connection Unit 14

As mentioned above, in order to be able to connect transceiver modules belonging to different MSA standards to the transceiver testing device 12, different interface connection units 14 are required. Each different interface connection unit 14 includes two connector components that are different from each other.

The structure of the interface connection units 14 will now be described in more detail with respect to the interface connection unit 14 shown in FIGS. 1A and 1B. As shown, the interface connection unit 14 includes a first connector component 20 that is adapted for being removably connected to the transceiver testing device 12. More specifically, the first connector component 20 is operative for being releasably connected to the connection port 18 on the transceiver testing device 12. In a non-limiting example of implementation, the connection port 18 of the transceiver testing device 14 is a high density electrical connector that includes a high density of electrical contact pins.

The interface connection unit 14 further includes a second connector component 22 that is operative for connecting to an MSA transceiver module, which in the case shown in FIGS. 1A and 1B is an optical MSA transceiver module 16. More specifically, the second connector component 22 is operative for being removably connected to an electrical connector 24 of the optical MSA transceiver module 16.

It should be understood that the second connector component 22 can only be connected to a single type of electrical connector type. Some non-limiting types of electrical connector types include 20 pins and 10 pins (SFP, SFF and GBIC transceivers), 30 pins (XFP transceivers), 40 pins (Tunable MSA transceivers), 70 pins (XENPAK/X2/XPAK transceivers) and 300 pins (300 pin MSA transceivers).

In the case where transceiver modules belong to different MSA standards, but have the same electrical connector type, a different interface connection unit 14 will be required for the transceiver modules belonging to each of these different MSA standard. For example, transceiver modules belonging to the XENPAK, XPAK and X2 MSA standards, which all have the same 70 pin electrical connector type, will each require a different interface connection unit 14. This is because the transceiver modules belonging to each of these different MSA standards are mechanically different. As such, different interface connection units 14 that have different internal signal pathways will be required.

Obviously, different interface connection units 14 will also be required for transceiver modules that belong to MSA standards that have different electrical connector types 24. As mentioned above, each of these different interface connection units 14 will include a common first connector component 20, such that the interface connection units 14 can be connected to the connection port 18 of the transceiver testing device 12, and a different second connector component 22. Each of the different second connector components 22 will correspond to a different electrical connector type of the MSA transceiver modules.

Based on the above description, it should be appreciated that it is the use of different interface connection units 14 that enables transceiver modules belonging to different MSA standards to be connected to the transceiver testing device 12, such that the transceiver testing device 12 can perform testing operations on transceiver modules belonging to different MSA standards.

In addition to being the physical bridge between the transceiver testing device 12 and the MSA transceiver modules, the interface connection unit 14 also acts as a conduit for transporting electrical signals between the transceiver testing device 12 and the MSA transceiver modules. As such, the interface connection unit 14 includes a plurality of signal pathways between the first connector component 20 and the second connector component 22. This permits signals to pass from connection port 18 of the transceiver testing device 12 to the electrical connectors 24 of the MSA transceiver modules.

In FIG. 1A, the interface connection unit 14 is shown connected to both the transceiver testing device 12 and the optical MSA transceiver module 16. In this position electrical signals can pass between the transceiver testing device 12 and the MSA transceiver unit 16, such that the transceiver testing device 12 can perform one or more testing operations on the MSA transceiver module 16.

The size of the connection port 18 on the transceiver testing device 12 is selected such that it has a sufficient number of input/output pins to accommodate transceiver modules belonging to the MSA standard that requires the most input/output connections; namely the 300 Pin MSA standard. This means that for transceiver modules that require less input/output pins, such as those belonging to the SFP 2.5 Gb/s MSA standard, the connector port 18 includes too many input/output pins. Since the first connector component 20 of the interface connection unit 14 is always the same regardless of the type of MSA transceiver module it supports, depending on the type of MSA transceiver module it supports, the internal signal pathways that connect to the input/output pins of the connector port 18 will be different. As such, for many interface connection units 14, not all the input/output pins of the connector port 18 are used.

For example, an interface connection unit 14 for connecting to optical transceiver modules belonging to the SFP MSA standard will include less signal pathways between the first and second connection components 20, 22, than an interface connection unit 14 for connecting to optical transceiver modules belonging to the XFP or 300 Pins MSA standards. In a non-limiting example of implementation, an SFP optical transceiver might require 4 LVDS differential lines within the interface connection unit 14, while an XFP optical transceiver might require 16 LVDS differential lines within the interface connection unit 14.

In a non-limiting example of implementation, the interface connection units 14 that do not use all of the input/output pins of the connection port 18 include termination resistors and capacitors at the first connector component 20 in order to avoid any noise.

In addition, in a non-limiting example of implementation, depending on the type of MSA transceiver module that is supported by the interface connection unit 14, the interface connection unit 14 may include a Serialiser/Deserialiser(SERDES). The serializer/deserializer is operative for converting signals in a serial bit stream format into signals in a parallel bit stream format, and vice versa.

Transceiver modules belonging to certain MSA standards issue electrical signals in a serial bit stream format. However, the transceiver testing device 12 requires signals to be in a parallel bit stream format in order to be analysed. As such, in order to solve this problem, a serializer/deserializer can be included within the interface connection unit 14 for transforming the serial bit stream signals of the MSA transceiver module 16 into parallel bit stream signals that can be analysed by the transceiver testing device 12.

In a non-limiting example, signals from an optical transceiver module belonging to the SFP at 2.48 Gb/s sec MSA standard are transformed into 4 differential lines of 622 Mb/s before they are passed into the transceiver testing device 12. As such in this embodiment the serializer/deserializer within the interface connection unit 14 can accept signals at any rate between 55 mbs to 2.6 Gb/s.

In another non-limiting example, signals from optical transceiver modules belonging to the 10 Gb/s XFP MSA standard, are transformed into 16 differential LVDS lines also at 622 Mb/s. It should be understood that the rate on the parallel side is dependant of the rate of the serial side (Anywhere between 622 Mb/s to 777 Mb/s for 9.95 Gb/s to 12.5 Gb/s). This transformation is done by the serializer/deserializer in the interface connection unit 14.

As such, the interface connection units 14 have the ability to bring high speed serial signals to lower speed parallel signals. In the case of optical transceiver modules belonging to the 300 pin MSA standard, the serialiser/deserialiser is already included in the optical transceiver, and as such no such part is needed within its corresponding interface connection unit 14. Likewise, in the case of optical transceiver modules belonging to the XENPAK MSA standard, the signals at 10 Gb/s stream are transformed into 4 parallel streams at 3.125 Gb/s each within the transceiver, and as such no serializer/deserializer is needed within its corresponding interface connection unit 14, since the transceiver can interface directly with the transceiver testing device 12.

In the non-limiting embodiment shown in FIGS. 1A and 1B, the interface connection unit 14 includes a fan (not shown) that is located within a fan housing 26. During operation, the interface connection unit 14 can generate quite a bit of heat. As such, the fan is included in order to remove some of the heat generated and prevent the electrical components and the MSA transceiver under testing from overheating. Fans and fan housings are known in the art, and any suitable fan, or heat sink can be used to dissipate the heat generated by the interface connection unit 14 without departing from the spirit of the invention.

In a further non-limiting example of implementation, each different type of interface connection unit 14 corresponds to associated computer readable program code. As will be described in more detail below, the computer readable program code can be executed by an external device, such as the CPU of a PC. In a first non-limiting example of implementation, the computer readable program code can generate a graphical user interface which would allow a user to access certain functions of the transceiver testing device 12 that will be described in more detail below. Such functions could be specific to the type of MSA transceiver module 16 that is supported by the interface connection unit 14. As such, the graphical user interface would reside on the PC and would communicate with the transceiver testing device 12 in order to configure the testing functionalities for that interface connection unit 14.

In a second non-limiting example of implementation, the computer readable program code can provide the transceiver testing device 12 with an indication of which type of test operations to perform on the MSA transceiver modules connected to the transceiver testing device 12. For example, the software can provide the transceiver testing device 12 with codes associated to specific testing operations. This will be explained in more detail further on in the description.

Transceiver Testing Devices 12 and 120

As mentioned above, transceiver testing devices in accordance with the present invention are operative to test transceiver modules belonging to different MSA standards. More specifically, the transceiver testing devices can perform testing operations on optical MSA transceiver modules, electrical MSA transceiver modules, or both optical and electrical MSA transceiver modules.

Testing Optical MSA Transceiver Modules

The transceiver testing device 12 shown in FIGS. 1A and 1B is operative for performing testing operations on optical MSA transceiver modules, such as optical transceiver module 16. It should be appreciated that the term “testing operations” can refer to any testing operations that are performed for the purposes of calibration, research and development, performance testing, validation testing and quality control testing.

As will be described in more detail below, the transceiver testing device 12 is operative for performing both electrical testing operations, and optical testing operations on the optical transceiver module 16. As such, the optical transceiver module 16 is in both electrical communication and optical communication with the transceiver testing device 12.

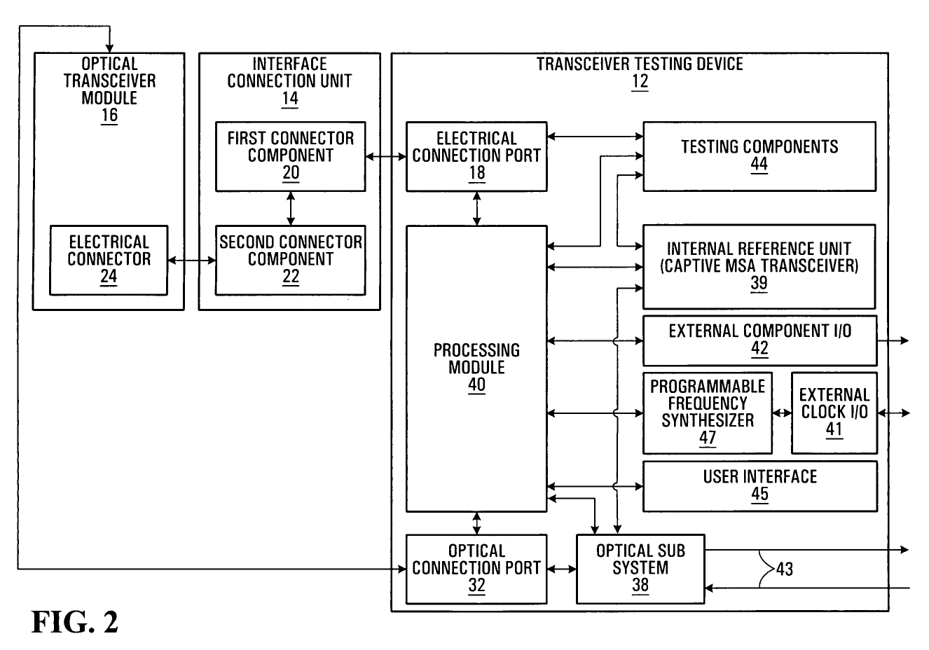

Shown in FIG. 2 is a block diagram of the transceiver testing system 10, with the transceiver testing device 12 shown in more detail. As described above, the transceiver testing device 12 includes an electrical connection port 18 for issuing or receiving electrical signals from the optical transceiver module 16. As such, electrical test signals issued from the transceiver testing device 12 travel from the electrical connection port 18 of the transceiver testing device 12, through the interface connection unit 14, and into the optical transceiver module 16 being tested. Electrical signals are returned from the optical transceiver module 16 to the transceiver testing device 12 via the same path.

The transceiver testing device 12 also includes an optical connection port 32 for issuing/receiving optical signals to/from the optical transceiver module 16. In the non-limiting embodiment shown in FIGS. 1A and 1B, the transceiver testing device 12 includes an optical connection port 32 that is suitable for receiving single mode fibres at a single mode input 33 and multi-mode fibres at a multi-mode input 34. It should be understood, however, that in an alternative embodiment, the transceiver testing device 12 may include only a single mode input 33 for receiving single mode fibres. In yet another alternative embodiment, the transceiver testing device 12 may include only a multi mode input 34 for receiving multi mode fibres.

The optical transceiver module 16 is connected to the optical connection port 32 of the transceiver testing device 12 via optical fibres 30. As such, the transceiver testing device 12 is operative for transmitting optical test signals to the transceiver module 16 through either single mode or multi-mode optical fibres 30.

Via the electrical connection port 18 and the optical connection port 32, the transceiver testing device 12 is able to transmit and receive the electrical and optical signals necessary for performing testing operations on the transceiver module 16.

As shown in FIG. 2, both the electrical connection port 18 and the optical connection port 32 are in communication with a processing module 40. It is the processing module 40 that is operative for causing at least one testing operation to be performed on the optical transceiver module 16. In a non-limiting example of implementation, the processing module 40 can be in the form of a microprocessor block, such as a uProc, Flash, SRAM or CPLD. In addition, the processing module 40 can include a field programmable gate array (FPGA). In general, the FGPA code is specific to a data rate, and contains features such as testing operations, which are rate dependent.

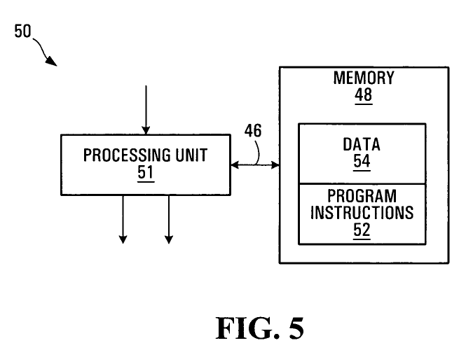

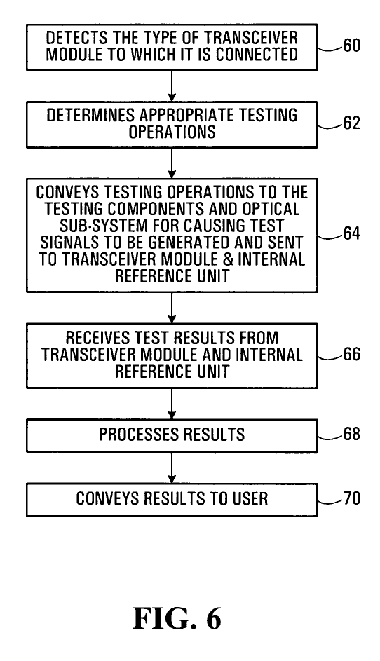

In a non-limiting example of implementation, the processing module 40 may be configured as a computing unit 50 of the type depicted in FIG. 5, including a processing unit 51 and a memory 48 connected by a communication bus 46. The memory 48 includes data 54, which could include data relating to different MSA standards and testing operations for example, and program instructions 52. The processing unit 51 is adapted to process the data 54 and the program instructions 52 in order to implement the process that will be described below with respect to FIG. 6.

Referring back to FIG. 2, the processing module 40 is in communication with a plurality of testing components 44 and an optical sub-system 38. In a non-limiting example of implementation, the testing components 44 and the optical subsystem 38 are under the control of the processing module 40 for generating the electrical test signals and optical test signals respectively for transmission to the optical transceiver module 16. For this reason, the testing components 44 are in communication with the electrical connection port 18, and the optical sub-system 38 is in communication with the optical connection port 32. The processing module 40 is also operative to process signals received from the optical transceiver modules for obtaining measurements associated with the test signals that have been generated. As such, not only is the processing module 40 operative for causing test signals to be sent to the optical transceiver module 16, but it is also operative for processing the signals received from the optical transceiver module 16 in response to the test signals.

Although testing components 44 have been shown in FIG. 2 to be a separate box for the purposes of clarity, the testing components 44 could have been included within the processing module 40. Some non-limiting examples of electrical testing components included within the testing components 44 include a test pattern generator that supports a plurality of data rates and data formats, a dedicated eye-mask tester that supports a plurality of data rates, a power supply generator and tester, an electrical noise source, a frequency generator and analyser and a bit-error rate tester. Some non-limiting examples of components included in the optical sub-system 38 include an optical spectrum analyser and a wavelength detector that both support a plurality of module wavelengths, a communication analyser, optical switches for optical path selections, an optical noise source, a stressed-eye generator and an optical power meter. It should be understood that more or less testing components can be included within the transceiver testing device 12 without departing from the spirit of the invention. Each of these individual components listed above is known in the art, and as such will not be described in more detail herein.

Using the above described components, the transceiver testing device 12 can generate electrical and optical test patterns with Bit Error Rate (BER) monitoring, alarm monitoring, custom patterns, user defined patterns, error injection, etc. In addition, the transceiver testing device 12 can perform power supply measurements (Current, Voltage and power), data rate selection with 1 Hz increment, monitoring of the interface of the transceiver memory map, monitoring of the various transceiver alarms and warnings, optical measurements like power meter (in db), wavelength meter (in nm), noise generation, jitter measurement and eye mask pattern measurement. In addition, the transceiver testing device 12 can select the various optical or electrical paths to verify both the RX and TX side of the transceiver module 16 together or independently. As such, the data path (TX and RX) can be isolated for troubleshooting purposes.

The processing module 40 is also in communication with an internal reference unit (Captive MSA transceiver) 39 that acts as an ideal MSA transceiver. For example, the internal reference unit can include the functionality of a multi-rate SFP transceiver between 155 Mb/s to 2.5 Gb/s and an XFP transceiver at a 10 Gb/s rate. As shown in FIG. 2, the internal reference unit 39 is also in communication with both the testing components 44 and the optical sub-system 38. As such, the test signals generated by the testing components 44 and the optical subsystem 38 are also sent to the internal reference unit 39 in addition to the optical transceiver module 16. The manner in with the internal reference unit 39 responds to the test signals generated by the testing components 44 and the optical subsystem 38, sets the standard against which the test results returned by the optical transceiver module 16 will be compared. In other words, the values returned by the internal reference unit 39 are compared at least in part to the results returned by the transceiver module 16 in order to determine whether the transceiver module 16 is in good working order, or how the transceiver module 16 needs to be adjusted or calibrated.

The processing module 40 is also in communication with an external component input/output port 42. The external component input/output port 42 can enable the transceiver testing device 12 to be connected to external controlling instruments that are not included internally within the group of testing components 44. The external component input/output port 42 can enable the testing device 12 to be connected to either an external processing unit, such as a personal computer (PC), a handheld computer or to a data network such as the internet. In this manner, the testing device 12 can receive information or send information through the external component input/output port 42.

The external component intpu/output port 42 could use physical connections such as, but not limited to, a DB-9 connector with RS-232 serial protocol, RJ-45 connector with TCP/IP protocol, USB connector with USB 1.1 or 2.0 protocol or GPIB connector with IEEE 488.2 protocol.

Alternatively, external optical testing components could be connected directly to the optical subsystem via optical connection lines 43. In a non-limiting example of implementation, the external testing instruments connected to the transceiver testing device 12 via the optical connection lines 43 are under the control of the personal computer connected to the external component input/output port 42 and send/receive optical signals to/from the MSA transceiver under test, via the optical sub-system 38.

Some non-limiting examples of external testing devices that could be connected to the transceiver testing device 12 include an optical spectrum analyser (OSA), a jitter test set, a power meter, optical switches, a wavelength meter, a communication analyser, a spectrum analyser, a fiber spool, a laser source, an optical amplifier and a tunable dispersion compensator. It should be understood that other external components not listed herein could also be connected to the transceiver testing device 12.

Additionally, the external component input/output port 42 can enable the testing device 12 to be connected to either an external processing unit, such as a personal computer (PC), a handheld computer or to a data network such as the internet. In this manner, the testing device 12 can receive information or send information through the external component input/output port 42.

In addition, the processing module 40 is also in communication with an external clock input/output 41. In certain applications it may be advantageous to rely on stable clock signals, which can be received directly from an external clock via the external clock input/output 41. As shown in FIG. 2, the processing module 40 is in communication with a programmable frequency synthesizer 47 that is positioned between the processing module 40 and the external clock input/output 41. In a non-limiting embodiment, the stable clock signals could also be provided from the programmable frequency synthesizer 47 that is in communication with the external clock input/output 41. In a non-limiting example, the programmable frequency synthesizer 47 is capable of handling frequencies in the range of 30 Mhz to 800 Mhz, with a 1 Hz step.

In accordance with a further non-limiting embodiment, the programmable frequency synthesizer 47 can also be used to issue via the external clock input/output 41 a signal that can be used as a trigger to synchronyze any external components or test equipment that are connected to the transceiver testing device 12, via the optical equipment I/O port 43. Alternatively, the programmable frequency synthesizer 47 can be used to monitor clock accuracy and stability. Both external clocks and programmable frequency synthesizers are known in the art, and as such will not be described in more detail herein.

Finally, the processing module 12 is in communication with a user interface 45. A non-limiting example of a user interface 45 is shown in FIG. 1A. In the non-limiting example shown, and as will be described in more detail below, the user interface 45 includes lights that are able to convey information to a user depending on whether the lights are on or off.

Although not shown in the figures, it is possible for the user interface 45 to include a display panel that is able to display some of the results of the testing operations. In addition, it is also possible for the user interface 45 to include user operable inputs, such as buttons and switches, for enabling the user of the transceiver testing device 12 to enter commands to the processing module 40.

Testing Electrical MSA Transceivers

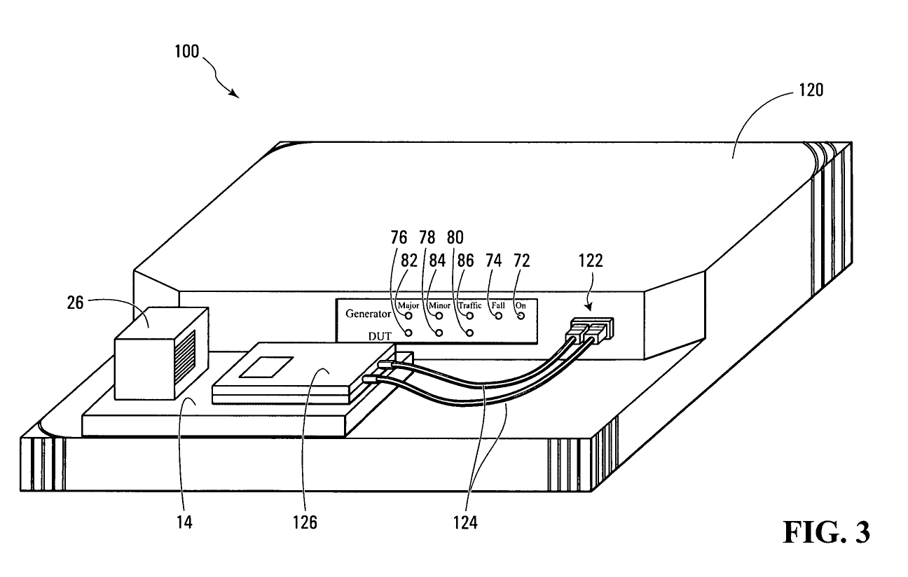

Shown in FIG. 3 is a transceiver testing system 100 that includes a transceiver testing device 120 that is operative for performing testing operations on electrical MSA transceiver modules 126. For the sake of simplicity, the parts of the transceiver testing system 100 that have already been described above with respect to FIG. 2 have been referred to with the same reference numbers.

As shown, the transceiver testing device 120 is in electrical communication with the electrical transceiver module 126 via two interfaces; namely through the interface connection unit 14 as described above, and through an electrical connection port 122. The electrical transceiver module 126 is adapted for being connected to the electrical connection port 122 of the transceiver testing device 120 via electrical wires, such as copper cables. In this manner, the transceiver testing device 120 is able to transmit and receive electrical signals to the transceiver module 126 through these electrical wires.

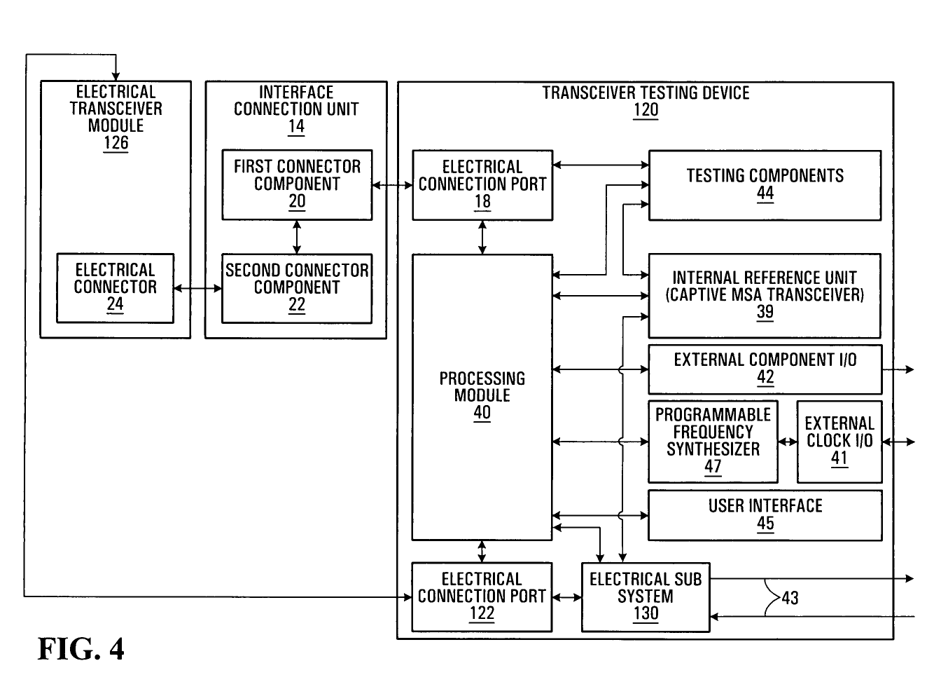

Shown in FIG. 4 is a block diagram of the transceiver testing device 120. Many of the components contained within the transceiver testing device 120 are the same as described above with respect to FIG. 2. As such, the processing module 40, the electrical connection port 18, the internal reference unit 39, the external component I/O 42, the programmable frequency synthesizer 47, the external clock I/O 41 and the user interface 45 have been referred to with the same reference numbers, and will not be described in more detail herein.

As described above, the transceiver testing device 120 is operative for issuing and receiving electrical signals to and from the electrical transceiver module 126 via the interface connection unit 14. As such, electrical test signals issued from the transceiver testing device 120 travel from the electrical connection port 18 of the transceiver testing device 120, through the interface connection unit 14, and into the transceiver module 126 being tested. Electrical signals are returned from the transceiver module 126 to the transceiver testing device 120 via the same path.

As shown in FIG. 4, the electrical connection port 122 is in communication with an electrical sub-system 130. This electrical sub-system 130 is in communication with both the internal reference unit 39 and the processing module 40. The processing module 40 is in communication with the electrical sub-system 130, such that it can cause the electrical subsystem 130 to generate electrical test signals for transmission to the electrical transceiver module 126. The electrical sub-system 130 can include testing components such as a test pattern generator that supports a plurality of data rates and data formats, a dedicated eye-mask tester that supports a plurality of data rates, a noise source, a bit-error rate tester and a spectrum analyser. It should be understood that more or less testing components can be included within the electrical sub-system 130 without departing from the spirit of the invention. Each of the individual components listed above is known in the art, and as such will not be described in more detail herein.

The electrical sub-system 130 is in communication with the internal reference unit (Captive MSA transceiver) 39 such that all the test signals generated by the electrical sub-system 130 are also sent to the internal reference unit 39. The manner in with the internal reference unit 39 responds to the test signals generated by the electrical subsystem 130 sets the standard against which the test results returned by the electrical transceiver module 126 will be compared. In other words, the values returned by the internal reference unit 39 are compared at least in part to the results returned by the electrical transceiver module 126 in order to determine whether the electrical transceiver module 126 is in good working order, or how the electrical transceiver module 126 needs to be adjusted or calibrated.

Via the electrical connection port 18 and the electrical connection port 122, the transceiver testing device 120 is able to transmit and receive the electrical signals necessary for performing testing operations on the transceiver module 126.

Testing Electrical MSA Transceivers

In the case of a transceiver testing device that is operative to test both optical and electrical transceiver modules, the transceiver testing device will include both an optical connection port that is in communication with an optical sub-system, as described above with respect to FIG. 2, and an electrical connection port that is in communication with an electrical sub-system 130, as described above with respect to FIG. 4.

Process Performed by the Processing Module 40

Regardless of whether the transceiver testing device is operative to test optical transceiver modules, electrical transceiver modules, or both, the general process performed by the processing module 40 is substantially the same. This general process will now be described in more detail below with respect to FIG. 6, and the transceiver testing device 12 shown in FIGS. 1A and 1B. It should be appreciated that the transceiver testing device 120 could also have been described for the purposes of this example.

Referring now to the flow-chart of FIG. 6, the process performed by the processing module 40 of the transceiver testing device 12 for testing an optical transceiver module 16 connected to the transceiver testing device 12 will now be described. This procedure begins once the transceiver module 16 has been connected to the transceiver testing device 12 via an appropriate interface connection unit 14.

At step 60, the processing module 40 detects the type of MSA transceiver module that is connected to the transceiver testing device 12. In other words, the processing module 40 detects to which MSA standard the transceiver module 16 connected to the transceiver testing device 12 belongs.

This can be done in a variety of different manners. In accordance with a first non-limiting example, the processing module 40 is told what type of transceiver module 16 is connected to the transceiver testing device 12 via information entered at a graphical user interface on a PC that is connected to the transceiver testing device 12. Specifically, the user is able to set up through the graphical user interface of the PC the type of protocol through which the transceiver testing device 12 can communicate with the specific transceiver module 16. For example, most of the transceiver modules use a 2 wire serial protocol called I2C. The Xenpak transceivers use a serial protocol called MDC/MDIO. As mentioned above, when a user connects a new type of transceiver module 16 to the transceiver testing device 12, the user can insert a compact disc, or other computer readable storage medium, into the PC. The PC can then execute the computer readable program code stored on the computer readable storage medium in order to initiate the appropriate GUI. The PC can then download any relevant information to the memory 48 of the processing module 40 of the transceiver testing device 12.

Alternatively, the processing module 40 can be told what kind of transceiver module 16 is connected to the transceiver testing device 12 via a signal entered by a user at the user interface 45.

In accordance with an alternative non-limiting example, the processing module 40 can determine the type of transceiver module 16 to which it is connected by detecting the pattern of signal pathways within interface connection unit 14. As mentioned above, depending on the type of transceiver module 16 supported by the interface connection unit 14, the interface connection unit 14 will include a different set of signal pathways connecting to the connection port 18 of the transceiver testing device 12. By detecting the pattern of the signal pathways within the interface connection unit 14, the processing module 40 can determine the type of transceiver module 16 to which it is connected.

In accordance with yet another alternative non-limiting example, the processing module 40 may determine the type of transceiver module 16 connected to the transceiver testing device 12 by initiating a testing operation that will be responded to differently by transceiver modules belonging to different MSA standards. As such, depending on the test result signals that are returned from the MSA transceiver module 16, the processing module 16 will be able to determine to which MSA standard the transceiver module 16 belongs.

It should be understood that step 60, which involves detecting the type of transceiver module 16 connected to the transceiver testing device 12, can be performed at various times during the operation of the transceiver testing device 12. For example, step 60 can be performed each time a new interface connection unit 14 is connected to the testing device 12. Alternatively, step 60 can be performed each time the transceiver testing device 12 is turned on. In accordance with yet another example, step 60 may be performed by the processing module 40 upon receipt of a signal indicative that the detection process should be performed. Such a signal could be entered via the user interface 45, or could be received from an external component such as a PC.

Once the processing module 40 has detected the type of transceiver module 16 that is connected to the transceiver testing device 12, the processing module 40 proceeds to step 62 wherein it determines the appropriate testing operations to be performed on the transceiver module 16 detected.

In a first non-limiting example, the processing module 40 can determine the appropriate testing operations to be performed on the detected transceiver module 16 by looking up the appropriate tests in its internal memory 48. For example, it is possible for the internal memory 48 of the processing module 40 to include data associating each different type of transceiver module 16 with an appropriate set of testing operations. As such, in order to determine the appropriate set of testing operations to apply to a specific type of transceiver module 16, the processing module 40 would perform a look-up operation in its internal memory 48 in order to determine the appropriate testing operations to be performed.

In an alternative example of implementation, the appropriate testing operations to be performed on the transceiver module 16 can be conveyed to the processing module 40 from an external component, such as a PC. For example, in the case where a PC is connected to the external component input/output port 42, the user can enter via a GUI on the PC the appropriate testing operations to be performed, which can then be downloaded from the PC to the processing module 40.

At step 64, the processing module 40 conveys to the testing components 44 and the optical subsystem 38 (or electrical subsystem 130 in the case of transceiver testing device 120) the testing operations to be performed on the transceiver module 16. In response to this information, the testing components 44 and the optical subsystems 38 generate the necessary test signals and transmit those test signals to the optical transceiver module 16 and to the internal reference unit 39.

Once the test signals have been transmitted to the transceiver module 16, the transceiver module 16 responds to these test signals by returning test result signals.

At step 66, the processing module 40 receives via the electrical connection port 18 and the optical connection port 32, the test result signals from the transceiver module 16. In addition, the processing module 40 receives test reference signals from the internal reference unit 39 that are indicative of how the internal reference unit 39 responded to the test signals generated by the testing components 44 and the optical sub-system 38. Ideally, it is desirable for the test result signals from the transceiver module 40 to be very similar to the test reference signals returned from the internal reference unit 39.

As such, at step 68 the processing module 40 processes the test result signals from the transceiver module 16 and the test reference signals from the internal reference unit 39 in order to determine whether the transceiver module 16 passes the testing operations. In a non-limiting example of implementation, the test result signals are processed on the basis of the test reference signals, and on the basis of certain criteria that are stored in the internal memory 48 of the processing module 40. Different manners in which the processing module 60 processes the test result signals and the test reference signals are known in the art and as such will not be described in more detail herein. For example, the test results can be collected, tagged, saved, retrieved, processed in order to derive statistics and archived.

Once the test result signals and the test reference signals have been processed, the processing module 40 proceeds to step 70, in which the results of the testing operations are conveyed to a user. The test results can be conveyed to a user in a variety of different manners.

In a first non-limiting example of implementation, the test results are conveyed to a user via the user interface 45 of the transceiver testing device 12. In the embodiment shown in FIG. 1A, the user interface 45 includes 8 lights in order to convey information to a user. Specifically, the user interface 45 includes an “on” light 72, which indicates that the transceiver testing device 12 is on, and a “fail” light 74, which indicates the general health of the testing device 12. In addition, the user interface 45 includes three lights that correspond to the transceiver module 16 (DUT—device under test), and three lights that correspond to the transceiver testing device 12 (generator). More specifically, each of the transceiver testing module 16 and the transceiver testing device 12 include a red light 76 under the heading “Major”, a yellow light 78 under the heading “Minor” and a green light 80 under the heading “Traffic”.

The transceiver testing device 12 is operative to use these lights in order to convey information to a user. For example, in order to indicate that there is a normal flow of traffic between the transceiver module 16 and the transceiver testing device 12, the processing module 40 will cause green lights 80 and 86 to be illuminated. When there is an error in the traffic, such as Bit Error Rate ratio error, the processing module 40 will cause yellow lights 78 and 84 to be illuminated. In addition, when there is no traffic flow between the transceiver module 16 and the transceiver testing device 12 the processing module 40 will cause the red lights 76 and 82 to be illuminated.

It should be appreciated that the above interface does not give the user specific information about the test results. As such, if the user is using the testing device 12 for research and development type testing, more information might be desired. As such, in a second non-limiting example of implementation, the test results can be conveyed to a user via a separate display apparatus, such as a computer monitor or a printing apparatus, that can be connected to the transceiver testing device 12 via the external component input/output port 42. In such an example much more detailed information can be provided to the user.

Once the procedure outlined in FIG. 6 is complete, a new transceiver module can be connected to the transceiver testing device, and the whole procedure can be re-started.

Alignment and Connection Device 90

As mentioned above, in a non-limiting embodiment, the connection port 18 of the transceiver testing device 14 is a high density electrical connector that includes a very high density of electrical contact pins. As such, in order to connect the first connector component 20 of the interface connection unit 14 to the connection port 18, great care must be taken. Specifically, the first connector component 20 must be aligned very carefully with the pins of the connection port 18 in order to avoid breaking any of the pins during connection. Given the high density of the pins in the connection port 18, this alignment can be very difficult to do manually.

As such, in a non-limiting example of implementation, the transceiver testing device 12 includes an alignment and connection device for facilitating the task of connecting the first connector component 20 of the interface connection unit 14 to the connection port 18 of the transceiver testing device 12, without damaging over time the high density connector.

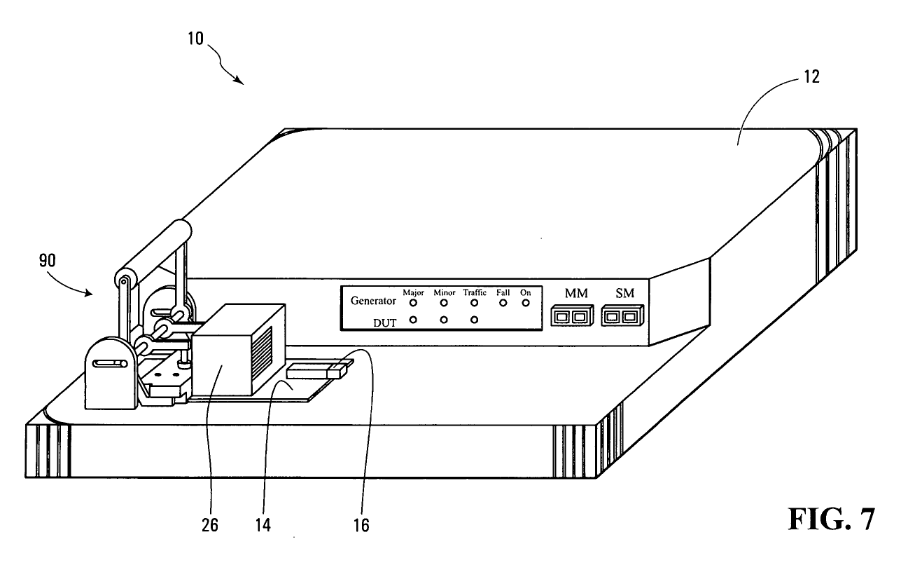

An alignment and connection device 90 in accordance with a first non-limiting embodiment is shown in FIG. 7. In this embodiment, the alignment and connection device 90 is positioned on the transceiver testing device 12. As shown, the alignment and connection device 90 includes a lever 91. When the interface connection unit 14 is positioned in the appropriate place, the lever 91 is moved downward such that it is operative for aligning the first connector component 20 of the interface connection unit 14 with the connection port 18 of the transceiver testing device 12, and for connecting the two parts together. The use of this alignment and connection device 90 greatly reduces the chance of damage being caused to either the connection port 18, or the first connector component 20.

In FIG. 7, the interface connection unit 14 is shown in a position wherein the first connector component 20 is connected to the connection port 18 of the transceiver testing device 12.

In order to connect the interface connection device 14 to the transceiver testing device 12, the interface connection device 14 is carefully positioned on the transceiver testing device 12 such that its first connector component 20 is positioned over the connection port 18 of the transceiver testing device 12. The lever 91 of the alignment and connection device 90 is then pulled downwards, such that a pressing portion 93 applies an even pressure to the top of the interface connection unit 14 for aligning and pushing the first connector component 20 into mating engagement with the connection port 18. As mentioned above, by using the alignment and connection device 90, the interface connection unit 14 can be connected to the transceiver testing device 12 with minimal chance of damaging either the connection port 18, or the first connector component 20.

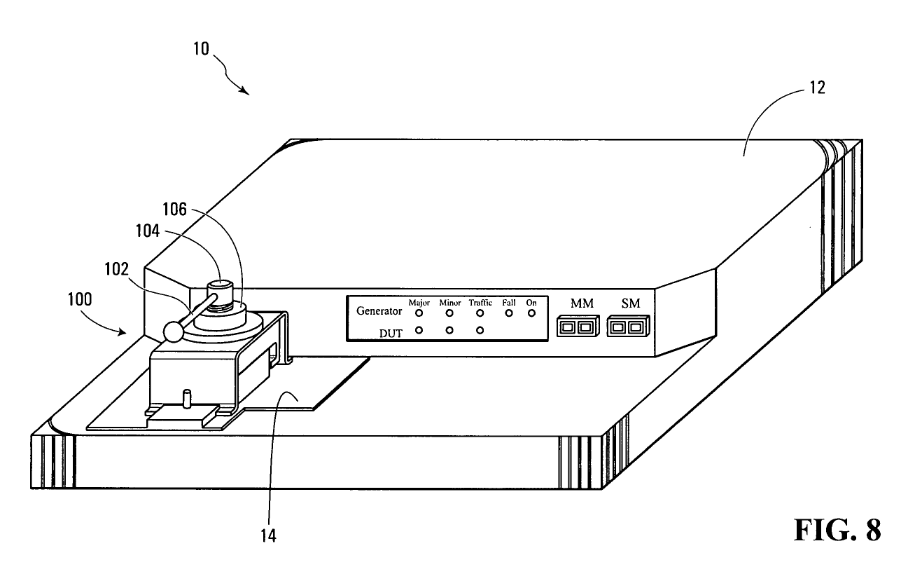

An alignment and connection device 100 in accordance with a second non-limiting embodiment is shown in FIG. 8. The alignment and connection device 100 is positioned on the transceiver testing device 12. As shown, the alignment and connection device 100 includes a rotating arm 102 that is connected to a screw 104. When the rotating arm 104 is rotated, the screw turns, thereby moving up or down with respect to the housing 106. A pressure portion (not shown) is connected to the screw 104, such that when the screw is rotated, the pressure portion also moves up or down with respect to the housing 106.

As such, in order to connect the first connector component 20 of the interface connection unit 14 to the connection port 18 of the transceiver testing device 12 the interface connection device 14 is carefully positioned on the transceiver testing device 12 such that its first connector component 20 is positioned over the connection port 18 of the transceiver testing device 12. The rotating arm 102 of the alignment and connection device 100 is then rotated, such that the screw 104 moves downwards in relation to the housing 106. In so doing, the pressing portion (not shown) moves downwards, and as such applies pressure to the top of the interface connection unit 14 for aligning and pushing the first connector component 20 into mating engagement with the connection port 18.

Although two alignment and connection device 90 and 100 have been described above, it should be understood that other mechanisms for consistently aligning and connecting the interface connection unit 14 with the transceiver testing device 12 could also be used without departing from the spirit of the invention.

Specific Physical Implementation

Those skilled in the art should appreciate that in some embodiments of the invention, all or part of the functionality of the transceiver testing device 12 can be implemented as pre-programmed hardware or firmware elements (e.g., application specific integrated circuits (ASICs), electrically erasable programmable read-only memories (EEPROMs), etc.), or other related components.

In other embodiments of the invention, all or part of the functionality previously described herein with respect to the processing module 40 may be implemented as software consisting of a series of instructions for execution by a computing unit. The series of instructions could be stored on a medium which is fixed, tangible and readable directly by the computing unit, (e.g., removable diskette, CD-ROM, ROM, PROM, EPROM or fixed disk), or the instructions could be stored remotely but transmittable to the computing unit via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

Although the present invention has been described in considerable detail with reference to certain preferred embodiments thereof, variations and refinements are possible without departing from the spirit of the invention. Therefore, the scope of the invention should be limited only by the appended claims and their equivalents.

We claim:

1. An interface connection unit suitable for connecting an MSA transceiver module to a transceiver testing device, said interface connection unit comprising:
a first connector component that is removably connectable to the transceiver testing device;
a second connector component different from said first connector component, said second connector component suitable for connecting to the MSA transceiver module;
wherein said interface connection unit comprises signal pathways between said first connector component and said second connector component for enabling the transceiver testing device to perform at least one testing operation on the transceiver module when the transceiver module is connected to the transceiver testing device via said interface connection unit.

2. An interface connection unit as defined in claim 1, wherein said signal pathways are electrical pathways.

3. An interface connection unit as defined in claim 2, wherein said first connector component is a high density electrical connector component.

4. An interface connection unit as defined in claim 1, wherein said second connector component is suitable for connecting to a transceiver compliant with at least one multi-source agreement (MSA) standard.

5. An interface connection unit as defined in claim 4, wherein said common connector type is one of a 300 pin connector elements, a 70 pin connector element, a 20 pin connector element, a 10 pin connector element, a 30 pin connector element and a 40 pin connector element.

6. In combination, an interface connection unit as defined in claim 1, and computer readable program code for execution on a processing module for enabling testing of the MSA transceiver module to be performed through said interface connection unit.

7. A plurality of interface connection units as defined in claim 1, wherein each one of the plurality of interface connection units includes:
a common first connector component;
a different second connector component.

8. An MSA transceiver testing device comprising:
a connection port adapted for interfacing with a first connector component of a removable interface connection unit;
a processing module for causing at least one testing operation to be performed on an MSA transceiver module via testing signals transmitted through said connection port, the MSA transceiver module including a connector element for interfacing with the interface connection unit, the connector element being different from the first connector component of the removable interface connection unit.

9. A transceiver testing device as defined in claim 8, wherein said processor issues electrical testing signals to the MSA transceiver module through said connection port.

10. A transceiver testing device as defined in claim 9, comprising a second connection port, said second connection port adapted for being connected to the transceiver module via an optical cable.

11. A transceiver testing device as defined in claim 10, wherein said processor exchanges optical signals with the optical transceiver module through said second connection port.

12. A transceiver testing device as defined in claim 11, wherein said second connection port is suitable for receiving at least one of a single mode fibre and a multi mode fibre.

13. A transceiver testing device as defined in claim 11, wherein said second connection port includes a first connection interface for receiving a single mode fibre and a second connection interface for receiving a multi mode fibre.

14. A transceiver testing device as defined in claim 9, comprising a second connection port, said second connection port adapted for being connected to the transceiver module via an electrical cable.

15. A transceiver testing device as defined in claim 8, including at least one external port for connecting said transceiver testing device to external testing instruments operative for performing testing of the MSA transceiver module via said transceiver testing device.

16. A transceiver testing device as defined in claim 15, wherein the external testing instruments include at least one of Optical Spectrum Analyser (OSA), a jitter test set, a power meter, optical switches, a wavelength meter, a communication analyser, a spectrum analyser, a fiber spool, a laser source, an optical amplifier and a tunable dispersion compensator.

17. A transceiver testing device as defined in claim 8, wherein said processing module is responsive to initiation commands for initiating a testing pattern.

18. A transceiver testing device as defined in claim 17, wherein said initiation commands are received from an external device.

19. A transceiver testing device as defined in claim 18, wherein said processing module issues signals to said external device in response to test results received from the MSA transceiver module, said external device being operative to convey said test results to a user.

20. A transceiver testing device as defined in claim 17, wherein said initiation commands are received from a user via a user interface.

21. A transceiver testing device as defined in claim 20, wherein said transceiver testing device is operative for conveying the results of said testing pattern to a user via said user interface.

22. A transceiver testing device as defined in claim 8, comprising an output port for transmitting data over a data communication network.

23. An transceiver testing device as defined in claim 8, comprising an alignment and connection device for connecting the first connector component of the removable interface connection unit with said connection port.

24. An transceiver testing device as defined in claim 23, wherein said alignment and connection device is a lever mechanism.

25. A system for testing transceiver modules associated to different multi-source agreement standards, said system comprising;
a transceiver testing device comprising a processor for performing at least one testing operation on an MSA transceiver module associated to a certain multi-source agreement standard;
an interface connection unit for connecting the MSA transceiver module to said transceiver testing device, the transceiver module including a certain type of electrical connector element, said interface connection unit comprising:
(i) a first connector component for removably connecting said interface connection unit to said transceiver testing device, said first connector component being different from the certain type of connector element of the MSA transceiver module;
(ii) a second connector component suitable for connecting said interface connection unit to the certain connector element of the MSA transceiver module.

26. A transceiver testing device as defined in claim 25, wherein said transceiver testing device is operative for being connected to MSA transceiver modules associated to different multi-source agreement standards via different intermediate interface connection units.

27. A transceiver testing device as defined in claim 26, wherein each one of the different intermediate interface connection units includes:
a common first connector component; and
a different second connector component.

28. A transceiver testing device as defined in claim 27, wherein the different multi-source agreement standards include at least two standards selected from the list comprising small form factor (SFF), small form factor pluggable (SFP), gigabit interface converter (GBIC), 300 pin MSA, Xenpak, Xpak, Xpak/X2, high speed form factor pluggable (XFP) and tunable laser.

29. A method for testing transceiver modules associated to different multi-source agreement standards, said method comprising;
connecting a transceiver module associated to a certain multi-source agreement standard to a transceiver testing device via an intermediate interface connection unit, wherein:
(i) the transceiver module associated to the certain multi-source agreement standard includes a certain type of connector element; and
(ii) the intermediate interface connection unit includes:
(I) a first connector component for connecting to the transceiver testing device, said first connector component being different from said certain type of connector element; and
(II) a second connector component for connecting to the certain type of connector element of the transceiver module;
performing at least one testing operation on the multi-source agreement transceiver module connected to said transceiver testing device via the intermediate interface connection unit.

30. A computer readable storage medium including a program element suitable for execution by a computing apparatus to perform a method of testing an MSA transceiver module, said method comprising:
(a) exchanging at least one preliminary test signal with the MSA transceiver module for identifying to which MSA standard the MSA transceiver module belongs;
(b) releasing a signal indicative of the MSA standard identified in step a).
